(19) United States
(12) Patent Application Publication
(10) Pub. No.: US 2026/0007567 A1
(43) Pub. Date: Jan. 8, 2026

(54) Tentacle Massager

(71) Applicant: Haiting XU, Fuzhou City (CN)

(72) Inventor: Haiting XU, Fuzhou City (CN)

(21) Appl. No.: 18/761,520

(22) Filed: Jul. 2, 2024

(51) Int. Cl. A61H 19/00; A61H 7/00; A61H 23/02

(52) U.S. Cl. CPC A61H 19/32; A61H 7/005; A61H 23/02; A61H 2201/0153; A61H 2201/1215; A61H 2201/1246; A61H 2201/1409; A61H 2201/1418; A61H 2201/1676

(57) ABSTRACT

Disclosed are a tentacle massager, including a main body and a driving device, the main body is a cavity with an accommodating space inside, at least one tentacle is provided extending from an upper portion of an outer wall of the main body, and a portion of the outer wall of the main body away from the tentacle is a gripping portion; and the driving device is arranged in the accommodating space, and the driving device actuates the main body and/or the tentacle to execute predetermined movements. The tentacles are designed to imitate human fingers. When in use, the tentacles and the wall surface of the main body rub against the penis to simulate the reciprocating stimulation of the human fingers. At the same time, when the tentacles move back and forth, the driving device provides vibration at a predetermined frequency of the main body and tentacles.

### TECHNICAL FIELD

The present disclosure herein relates to the field of adult sexual products, in particular to a tentacle massager.

### BACKGROUND

Among adult products, there are some sex products that simulate the human body to achieve a simulated touch effect, such as simulating the licking action of the human body through a swinging mechanism and a tongue. However, there are currently relatively few adult sex products for men on the market, mainly airplane cups. However, airplane cups have the following shortcomings: 1. they are larger in size, less portable, and heavier; 2. airplane cups can provide a more multi-level stimulating experience, but the corresponding price is also higher, which affects the promotion of this category of products.

### SUMMARY

The main purpose of the present disclosure is to propose a tentacle massager, which aims to improve the existing male adult products and make them smaller in size, while also being able to simulate human body touch to provide a richer sense of stimulation.

In order to achieve the above purpose, the present disclosure proposes a tentacle massager, including:
a main body, wherein the main body is a cavity with an accommodating space inside, at least one tentacle is provided extending from an upper portion of an outer wall of the main body, and a portion of the outer wall of the main body away from the tentacle is a gripping portion; and
a driving device, wherein the driving device is arranged in the accommodating space, and the driving device actuates the main body and/or the tentacle to execute predetermined movements.

The tentacles are designed to imitate human fingers. When in use, the tentacles and the wall surface of the main body rub against the penis to simulate the reciprocating stimulation of the human fingers. At the same time, when the tentacles move back and forth, the driving device provides vibration at a predetermined frequency of the main body and tentacles, which can effectively increase the stimulation of the sensitive parts of the penis and further enhance the user experience. This structure is small in size, portable, and easy to use.

### BRIEF DESCRIPTION OF THE DRAWINGS

FIG. 1 is a three-dimensional schematic diagram when a tentacle is a sheet-like structure;

FIG. 2 is a cross-sectional view when a tentacle is a sheet-like structure;

FIG. 3 is a schematic diagram when a tentacle is a strip-like structure and is arranged on a side wall of a main body;

FIG. 4 is a schematic diagram when a tentacle is a strip-like structure and is arranged on an upper end of a main body; and

FIG. 5 is a schematic diagram when a tentacle is a swinging structure.

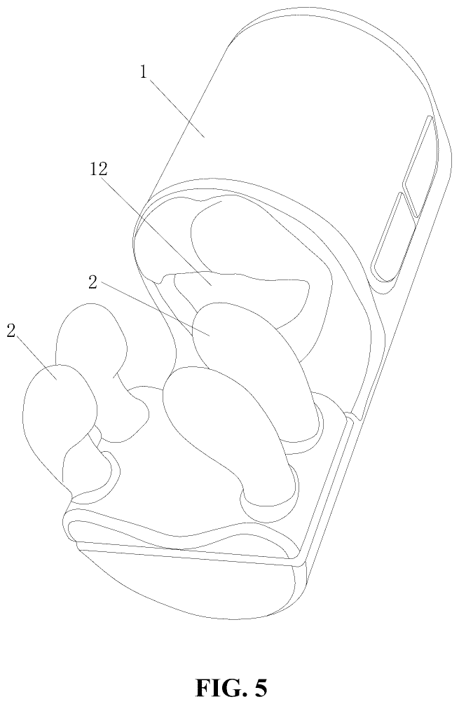

In the accompanying drawings,
1, main body; 10, accommodating space; 11, gripping portion;
2, tentacle; 20, tail portion;
3, driving device;
4, surrounding portion; 40, covering cavity; and
5, massage head.

### DETAILED DESCRIPTION OF THE EMBODIMENTS

The technical solutions in the embodiments of the present disclosure will be clearly and completely described below with reference to the accompanying drawings. Obviously, the described embodiments are only some of the embodiments of the present disclosure, not all of them. Based on the embodiments of the present disclosure, all other embodiments obtained by those skilled in the art without creative efforts fall within the scope of protection of the present disclosure.

It should be noted that if there are directional indications (such as up, down, left, right, front, back, top, bottom, inside, outside, vertical, transverse, longitudinal, counterclockwise, clockwise, circumferential, radial, axial . . . ), this directional indication is only used to explain the relative positional relationship, movement, etc. between the components in a specific posture (as shown in the accompanying drawings). If the specific posture changes, the directional indication also changes accordingly.

In addition, if there are descriptions involving “first” or “second” etc. in the embodiments of the present disclosure, the descriptions of “first” or “second” etc. are only for descriptive purposes and cannot be understood as instructions or implying its relative importance or implicitly specifying the quantity of the technical feature indicated. Therefore, features defined as “first” and “second” may explicitly or implicitly include at least one of these features. In addition, the technical solutions in various embodiments may be combined with each other, provided that such combinations are realizable by those skilled in the art. Where the combination of technical solutions is contradictory or unfeasible, it shall be deemed that such a combination does not exist and is not within the scope of protection required by the present disclosure.

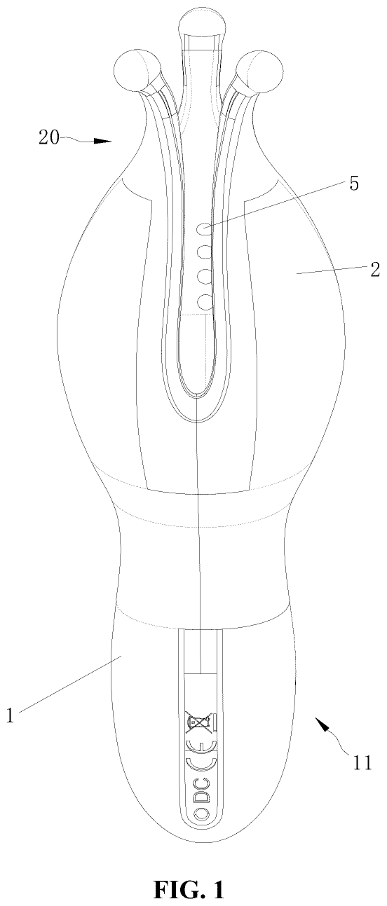

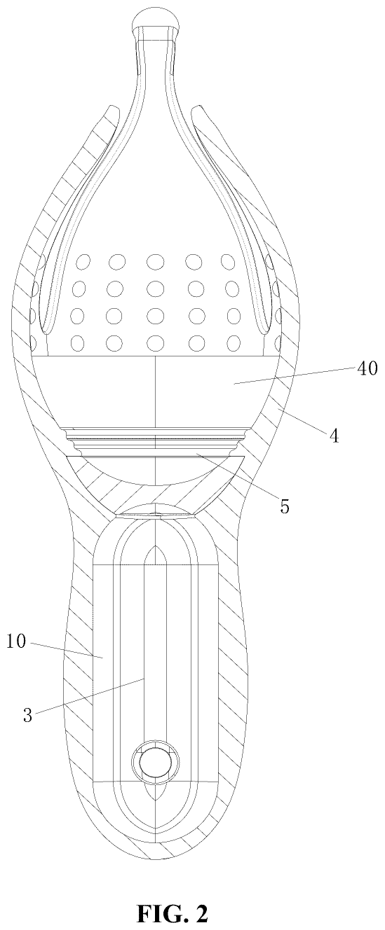

As shown in FIG. 1 to 4, a tentacle massager, including:
a main body 1, wherein the main body 1 is a cavity with an accommodating space 10 inside, at least one tentacle 2 is provided extending from an upper portion of an outer wall of the main body 1, and a portion of the outer wall of the main body 1 away from the tentacle 2 is a gripping portion 11; and
a driving device 3, wherein the driving device 3 is arranged in the accommodating space 10, and the driving device 3 actuates the main body 1 and/or the tentacle 2 to execute predetermined movements.

The tentacles 2 are designed to imitate human fingers. When in use, the tentacles 2 and the wall surface of the main body 1 rub against the penis to simulate the reciprocating stimulation of the human fingers. At the same time, when the tentacles 2 move back and forth, the driving device 3 provides vibration at a predetermined frequency of the main body 1 and tentacles 2, which can effectively increase the stimulation of the sensitive parts of the penis and further enhance the user experience. This structure is small in size, portable, and easy to use.

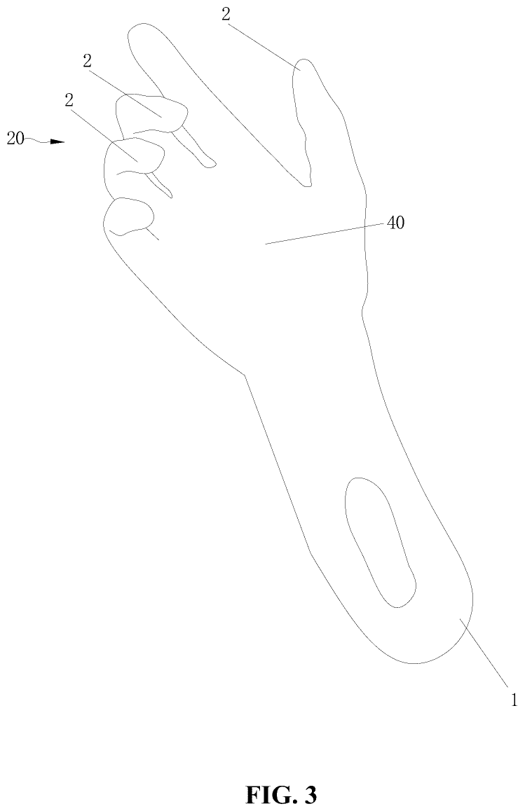

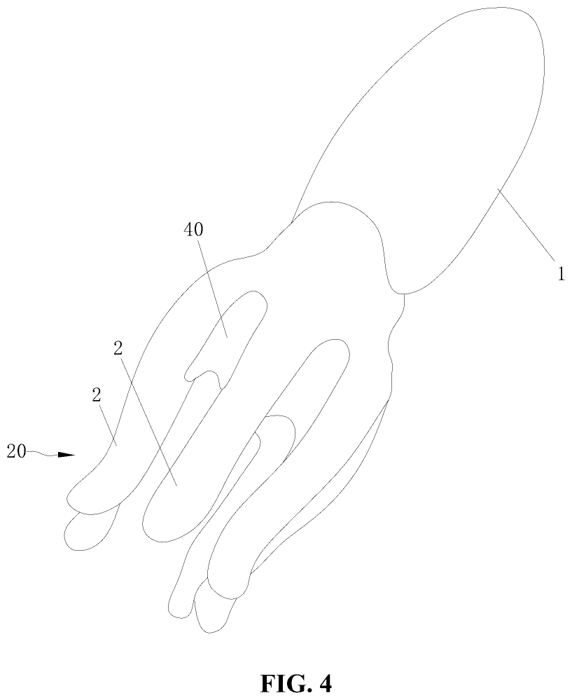

Specifically, the tentacle 2 is a sheet-like structure or a strip-like structure. In actual design, the tentacles 2 can be designed as a strip-like structure as shown in FIGS. 3 and 4, or as a sheet-like structure as depicted in FIG. 1, depending on the actual design. The preferred number of tentacles 2 is within ten, with three, four, five, and six being the optimal choices.

In the embodiment of the present disclosure, the tentacle 2 is provided extending upward from the upper portion of the main body 1 or extending outward from a side wall of the main body 1. The tentacles 2 extending outward from the side wall of the main body 1 may extend obliquely or horizontally (preferably with multiple tentacles extending in the same direction), thereby forming a predetermined shape. For upward extension, please refer to FIG. 1.

The tentacle is entirely made of a flexible material, or an outer peripheral wall of the tentacle is protected by the flexible material.

For example, the inner portion of the flexible tentacles is provided with an airbag inside that drives the swinging of the flexible tentacles through its expansion and contraction. Alternatively, a rotating motor, cam, and swing arm structure can be utilized to achieve the swinging motion of the flexible tentacles.

Specifically, tail portions 20 of the tentacle 2 are close to each other, and are arranged such that they are either in contact or adjacent to each other. Based on practical needs, the tail portions 20 can be brought closer or in contact with each other. During reciprocating movement, the penis is provided through the tail portions 20 to imitate the touch and stimulation of human tentacles, and a stronger sensation of stimulation is achieved under the vibration of the driving device 3. Of course, the sensation of touch can also be enhanced by installing a protruding structure at the tail end of the tentacles.

When it is the sheet-like structure, the tentacle is gradually reduced in diameter from the main body 1. Of course, the sheet-like structure can also be in the shape of a strip.

Specifically, the main body 1 is provided with a surrounding portion 4 extending toward the tentacle 2, and the surrounding portion 4 and an upper wall or side wall of the main body 1 form a covering cavity 40. Through the arrangement of the covering cavity 40, the contact area between the penis head and the massager is further increased, thereby enhancing the sensation of neural stimulation.

In the embodiment of the present disclosure, the surrounding portion 4 is provided between two adjacent tentacles 2;
The surrounding portion 4 extends circumferentially from a wall surface of the main body 1, and the tentacle 2 is provided at an end of the surrounding portion 4 away from the main body 1.

When the surrounding portion 4 is disposed between the two tentacles 2, the wall thickness of the surrounding portion 4 can be thinner than the wall thickness of the tentacles 2, thereby enhancing the softness of the massager and making it more akin to the softness of human hands;
of course, it can also be directly extended from the main body 1 to increase the contact area.

The surrounding portion can be a fully enclosed or semi-enclosed structure, such as completely enclosing the head of the penis or enclosing one side of the head of the penis.

Specifically, a point-shaped, strip-shaped or block-shaped massage head is protruded on an inner wall of the covering cavity 40 and/or an inner wall of the tentacle 2, thus enhancing the stimulation on the penis head and improving sensitivity under the action of the driving device 3. Of course, the massage head 5 can also be designed in a groove shape to achieve corresponding stimulation effects.

When it is the strip-like structure, the whole body is in a hand-like structure or an octopus-like structure

Specifically, the driving device is driven by a vibration motor, a vacuum pump, or a rotating motor cooperating with a cam, which is utilized to provide a predetermined vibration.

The main body is provided with a channel 12 for an end portion of the penis to insert, and the driving device is disposed inside the channel, wherein the driving device can be a vibration motor or an air pump, thereby achieving predetermined stimulation (such as suction) on the sensitive part of the penis in the channel.

The above are only preferred embodiments of the present disclosure, and do not limit the patent scope of the present disclosure. Any equivalent structural modifications made under the inventive concept of the present disclosure, utilizing the contents of the specification and drawings of the present disclosure, or the direct/indirect application in other related technical fields, are all included within the scope of patent protection of the present disclosure.

1. A tentacle massager, comprising:
a main body, wherein the main body has a cavity with an accommodating space inside, at least 3 tentacles with a covering cavity between each of the tentacles are provided extending from an upper portion of an outer wall of the main body, and a portion of the outer wall of the main body away from the tentacle is a gripping portion; and
a driving device, wherein the driving device is arranged in the accommodating space, the driving device actuates the main body and/or the tentacle to execute predetermined movements, and the accommodating space is provided with a power supply electrically connected to the driving device inside;
wherein the main body is provided with a surrounding portion extending toward the at least 3 tentacles, and the surrounding portion and an upper wall or side wall of the main body form a covering cavity.

2. The tentacle massager according to claim 1, wherein the at least one tentacle is a sheet-like structure or a strip-like structure; and
the at least 3 tentacles are entirely made of a flexible material, or an outer peripheral wall of the tentacle is protected by the flexible material.

3. The tentacle massager according to claim 1, wherein the tentacle is provided extending upward from the upper portion of the main body or extending outward from a side wall of the main body; and tail portions of the at least 3 tentacles are close to each other and are arranged in contact or adjacent to each other.

4. The tentacle massager according to claim 1, wherein the main body is provided with a channel for an end portion of the penis to insert, and the driving device is disposed inside the channel;
the channel and the accommodating space overlap partially, wherein the driving device is disposed at least partially in the overlap.

5. The tentacle massager according to claim 2, wherein the at least 3 tentacles haves a sheet-like structure, and a dimension of the tentacle is gradually reduced as the tentacle extends from the main body.

6. (canceled)

7. The tentacle massager according to claim 1, wherein the surrounding portion is provided between two adjacent tentacles; and
the surrounding portion extends circumferentially from a wall surface of the main body, and the two adjacent tentacles are provided at an end of the surrounding portion away from the main body.

8. The tentacle massager according to claim 6, wherein a point-shaped, strip-shaped or block-shaped massage head is protruded on an inner wall of the covering cavity and/or an inner wall of the tentacle.

9. The tentacle massager according to claim 2, wherein when the at least 3 tentacles haves a strip-like structure, and the main body has a hand-like structure or an octopus-like structure.

10. The tentacle massager according to claim 1, wherein the driving device is driven by a vibration motor, a vacuum pump, or a rotating motor cooperating with a cam.
